(19) United States
(12) Patent Application Publication
(10) Pub. No.: US 2023/0206290 A1
(43) Pub. Date: Jun. 29, 2023

(54) Bar Area Sales Automatic Tracking and Monitoring Method, and Bar Area Sales Automatic Tracking and Monitoring System

(71) Applicant: Wei Chang Jack Huang, Pasadena, CA (US)

(72) Inventor: Wei Chang Jack Huang, Pasadena, CA (US)

(21) Appl. No.: 17/646,150

(22) Filed: Dec. 28, 2021

(51) Int. Cl. G06Q 30/02; G06Q 50/12; G06T 7/20; G06T 7/70; G06V 20/40; G06V 40/20

(52) U.S. Cl. CPC G06Q 30/0283; G06Q 50/12; G06T 7/20; G06T 7/70; G06V 20/44; G06V 40/20

(57) ABSTRACT

Disclosed are a bar area sales automatic tracking and monitoring system and method, configured for tracking bar area sales using an image capturing device, wherein a transaction zone is defined on the bar counter; the system includes a memory device and a processing device, wherein the processing device further includes a drink pouring determining unit and a transaction determining unit; the method includes steps of: a) obtaining, by the image capturing device, at least one image data including a drink bottle, a drink glass and the transaction zone, and transmitting the image data to the processing device; b) identifying, by the drink pouring determining unit, whether the image data includes a figure tilting the drink bottle and pouring a drink into the glass; c) determining, by the transaction determining unit, the glass with the drink has crossed the transaction zone; and d) determining, by the transaction determining unit, that transaction of the glass of drink is completed when the glass with drink has crossed the transaction zone.

### FIELD

Embodiments of the present disclosure relate to a sales monitoring system and method, and more particularly relate to a bar area sales automatic tracking and monitoring method, and a bar area sales automatic tracking and monitoring system.

### BACKGROUND

Bartenders are essential in bar culture. Duties of a bartender involve serving ordered drinks, sometimes making recommendations, even mixing drinks like performing a show, or chatting with customers to liven up the atmosphere. This is why a bar cannot solely rely on automatic machines in their sales and services.

However, if the bar relies too much on bartenders to sell, it would be difficult to track sales activities. In some scenarios, bartender theft, i.e., making drinks but not entering into a POS (Point of Sale) terminal, might occur. For example, under-ringing revenues to pocket cash payments; secretly serving customers more drinks, over-pouring, or substituting to more expensive drinks due to personal relationship or for soliciting greater tips. With whiskey as an example, the prices for different distilleries or different production years vary greatly; however, the volume of a glass of whiskey is only about 30˜45 ml, or 1 to 1.5 oz, and with water or ice cubes being added, different types of whiskey can hardly be distinguished from the appearance, needless to mention cocktails that have complex mixing procedures and ingredients. Except the bartender who pours and mixes the drink, probably nobody knows the true value of the glass of cocktail.

Particularly under long-hour work, even with camera data, nobody can tell accurately in real time whether a revenue loss is caused by incidental bartender negligence or intentional theft and misappropriated. The above situations are unfavorable to the businesses, but hardly avoidable. If there lack effective control measures and systems in a long term, the situations will become increasingly deteriorated. Furthermore, to avoid unstable customer base due to frequent personnel change, the management is reluctant to dismiss a suspected bartender unless the bartender's behaviors are outrageous to him; even so, misjudgment can still be hardly avoided. A bigger problem is that even the suspected bartender is dismissed, the moral character, work ethic, and attentiveness of a new replacement bartender are still not assured to the management. Therefore, personnel change seems like a lottery to the management, increasing overheads but potentially in vain.

As such, most of bar owners or management, would turn a blind eye to the suspected bartenders; estimates show that bartender theft results in an average 10%˜20% revenue loss per year. To eliminate such hidden costs, many managements currently hire an additional supervisor 90 to supervise the bar activities during operating hours or install a surveillance camera device 92 for continuous recording, as illustrated in FIG. 1. However, irrespective of which manner is adopted, extra personnel overheads are incurred; besides, the supervisor is likely reluctant to change a familiar, skilled bartender. Therefore, such measures are not so cost-effective to the business. In view of the above, it is desirable to provide a system that can be widely applied and commercialized so as to track bar counter sales accurately, inform the bar staff of such accountable system, reduce bar thefts, and lower extra personnel overheads.

### SUMMARY

An object of the present disclosure is to provide a bar area sales automatic tracking and monitoring system, which is configured to analyze and determine a count of drinks made, and/or the value of each transaction, and further accurately track sales of a bar area by automatically analyzing relevant video data of the bar area.

Another object of the present disclosure is to provide a bar area sales automatic tracking and monitoring system, which is configured to render objective tracking and recording by analyzing bottles, glassware, drink pouring motions, and transaction motions, using a machine vision-enabled processing device in cooperation with an image capturing device.

An even further object of the present disclosure is to provide a bar area sales automatic accounting and monitoring system, which is configured to identify motions of each bartender using machine vision and define an alert threshold to expose a theft.

Still another object of the present disclosure is to provide a bar area sales automatic tracking and monitoring system, which is configured to accurately track a ring-up count and/or dollar amount via cooperation between a processing device and a cash register.

Even still another object of the present disclosure is to provide a bar area sales automatic tracking and monitoring method, wherein an image capturing device captures outer appearances of bottles and glassware for a processing device to analyze and validate type, volume and price of a drink, thereby accurately tracking a sales amount.

Still yet another object of the present disclosure is to provide a bar area sales automatic tracking and monitoring method, wherein an image capturing device captures tilt angle of a bottle and motions of a bartender for a processing device to analyze and identify type, volume, and actual price of a glass of drink.

Further still object of the present disclosure is to provide a bar area sales automatic tracking and monitoring method, wherein an image capturing device captures movement of a glass of drink on a bar counter for a processing device to analyze whether a transaction is established, and the image capturing device is connected to a Point of Sales system (POS) to validate whether a payment amount is reasonable.

The bar area sales automatic tracking and monitoring system according to the present disclosure is configured for a monitoring terminal to track sales of at least one bar area using an image capturing device; wherein a transaction zone is defined on the bar counter, and the image capturing device is configured to obtain at least one image data including a drink bottle, a drink glass and the transaction zone; wherein the bar area sales automatic tracking and monitoring system comprises: a memory device configured to store an image of the drink bottle; and a processing device configured to receive a signal of the image data from the image capturing device, wherein the processing device comprises a drink pouring determining unit and a transaction determining unit, wherein the drink pouring determining unit is configured to determine whether the drink bottle is tilted and a drink is poured into the glass based on the image data, and the transaction determining unit is configured to determine whether the glass poured with the drink has crossed the transaction zone based on the image data.

According to the bar area sales automatic tracking and monitoring system and method according to the present disclosure, an automation system is constructed with a memory device, a machine vision-enabled processing device, and an image capturing device with sufficient definition. The method comprises steps below: a) obtaining, by the image capturing device, at least one image data including a drink bottle, a drink glass and a transaction area, and transmitting the image data to the processing device; b) identifying, by the drink pouring determining unit, whether the image data includes a figure tilting the drink bottle and pouring a drink into the glass; c) determining, by the transaction determining unit, the glass with the drink has crossed the transaction zone; and d) determining, by the transaction determining unit, that transaction of the glass of drink is completed when the glass with drink has crossed the transaction zone. In this way, with relevant software and hardware devices being installed, a bar management is enabled to perform relevant analysis of bartender sales, which, on one hand, effectively solves the problem of accurately tracking bar counter sales, and on the other hand, reduces extra personnel overheads; furthermore, objective data analysis may tell the management accurately whether a revenue loss is caused by incidental negligence or habitual theft, such that a good bartender will not be wrongly accused while a cheating bartender will not be ignored, thereby solving the above problems.

### BRIEF DESCRIPTION OF THE SEVERAL VIEWS OF THE DRAWINGS

FIG. 1 is a schematic diagram of conventional bar area monitoring;

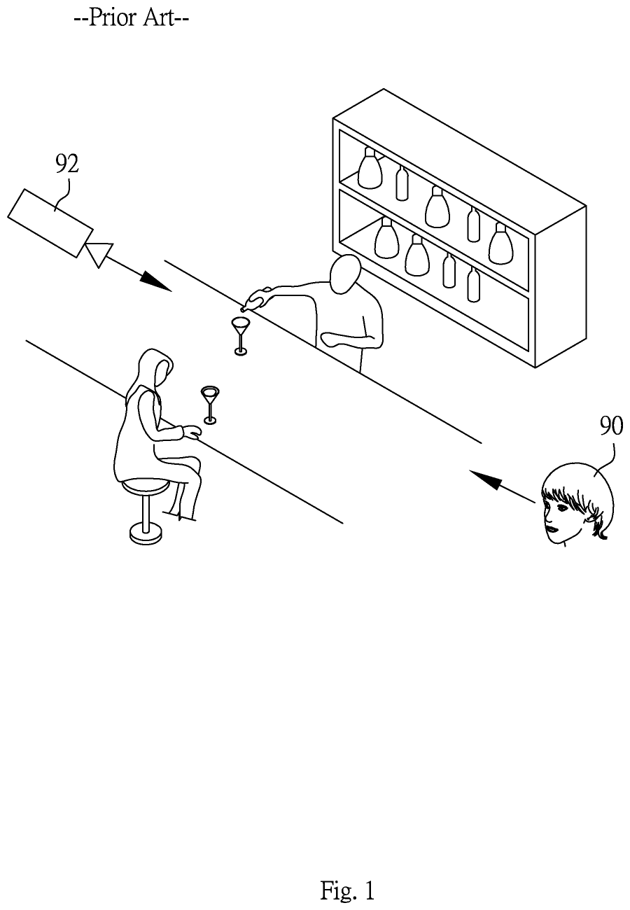

FIG. 2 is a block diagram of a bar area sales automatic tracking and monitoring system according to a first preferred embodiment of the present disclosure, showing main components;

FIG. 3 is a flow chart of a bar area sales automatic tracking and monitoring method according to the first preferred embodiment, showing operation steps;

FIG. 4 is a stereoscopic schematic diagram of a bar area for the embodiment of FIG. 2;

FIG. 5 is a schematic diagram of a pose of a bartender pouring wine;

FIG. 6 is a schematic diagram of a pose of a bartender pouring liquor;

FIG. 7 is a schematic diagram of a pose of a bartender pouring beer from a beer keg;

FIG. 8 is a flow chart of a bar area sales automatic tracking and monitoring method according to a second preferred embodiment;

FIG. 9 is a stereoscopic schematic diagram of a bar area sales automatic tracking and monitoring system according to the second preferred embodiment of the present disclosure;

### DETAILED DESCRIPTION

Relevant technical contents, features and effects of the present disclosure will become apparent through detailed description of the preferred embodiments with reference to the accompanying drawings, wherein like or similar components in various embodiments are represented by like or similar reference numerals.

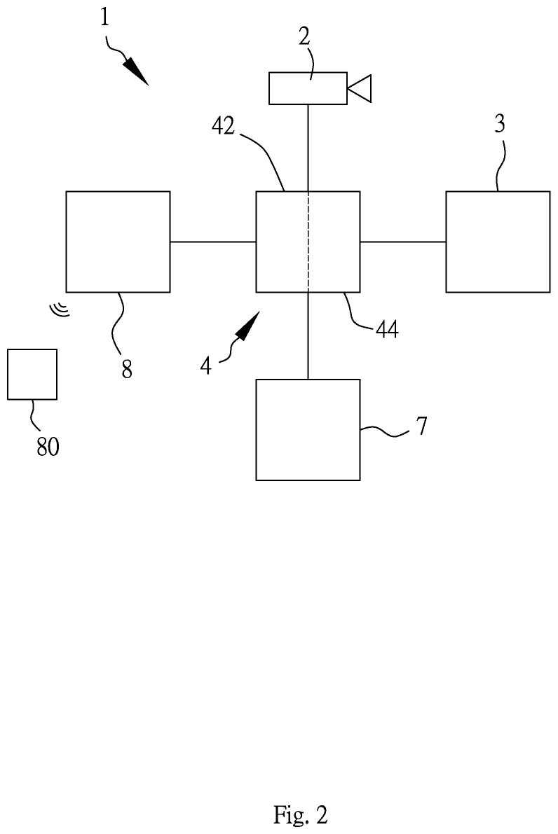

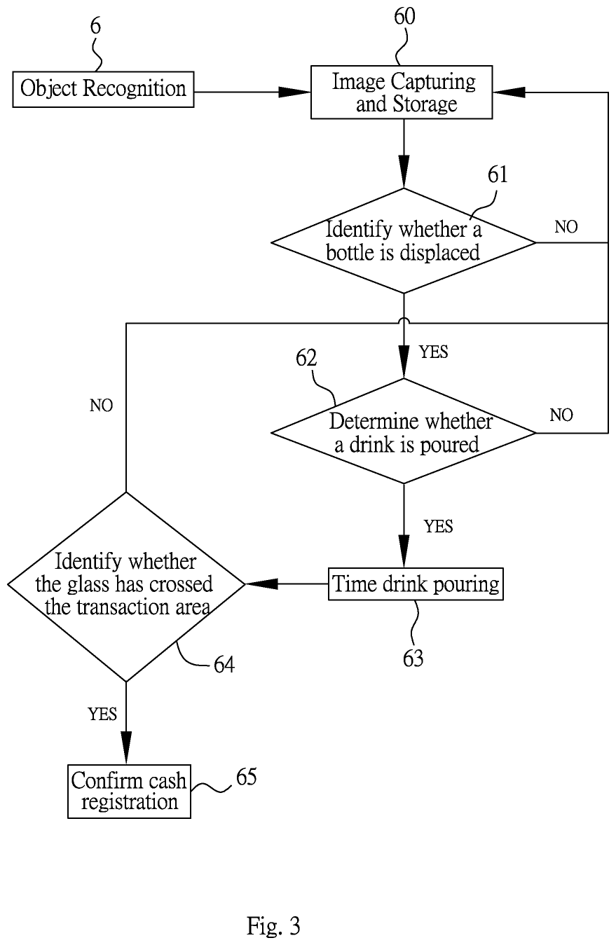

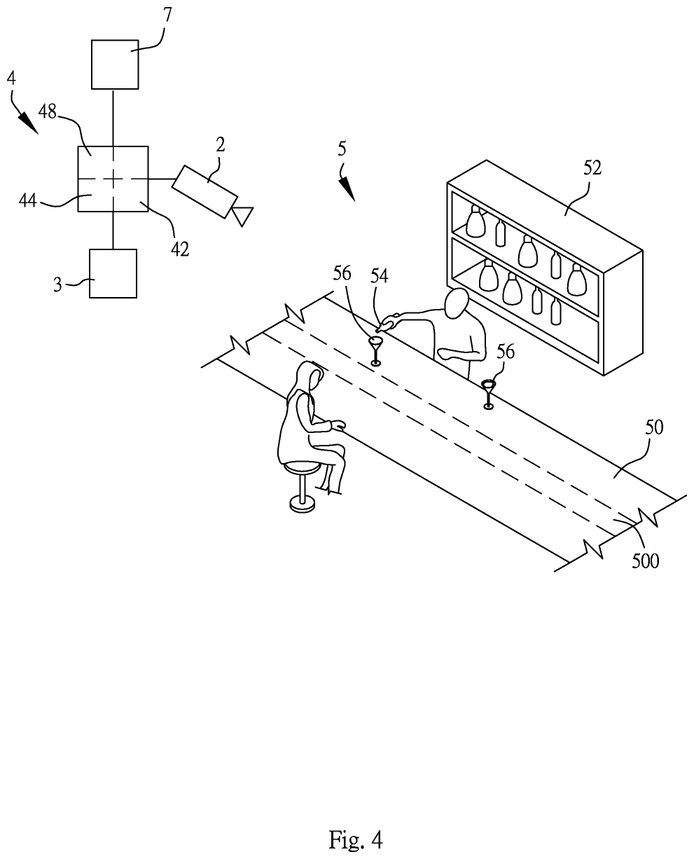

FIG. 2 shows a first preferred embodiment of a bar area sales automatic tracking and monitoring system 1 according to the present disclosure, comprising: at least one image capturing device 2, a memory device 3, and a processing device 4, wherein the processing device 4 further comprises a drink pouring determining unit 42 and a transaction determining unit 44. In this embodiment, the processing device 4 preferably comprises an object recognizing unit and a payment determining unit. FIG. 3 and FIG. 4 illustrate a first embodiment of a bar area sales automatic tracking and monitoring method, wherein in step 6 of object recognition, the image capturing device 2, an example of which is a dynamic range camera, captures image data of a bar counter 50, a drink cabinet 52, a drink bottle 54, and glassware 56 in a bar 5 one by one and records the image data in the memory device 3. The processing device 4 is further subjected to identification training such that it has the capacity to process and analyze the image data. Since such machine vision technologies have become increasingly mature, they will not be detailed here.

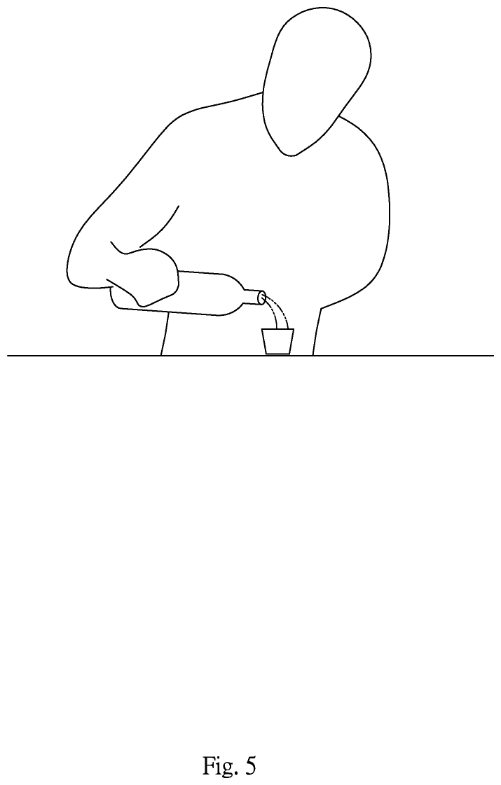

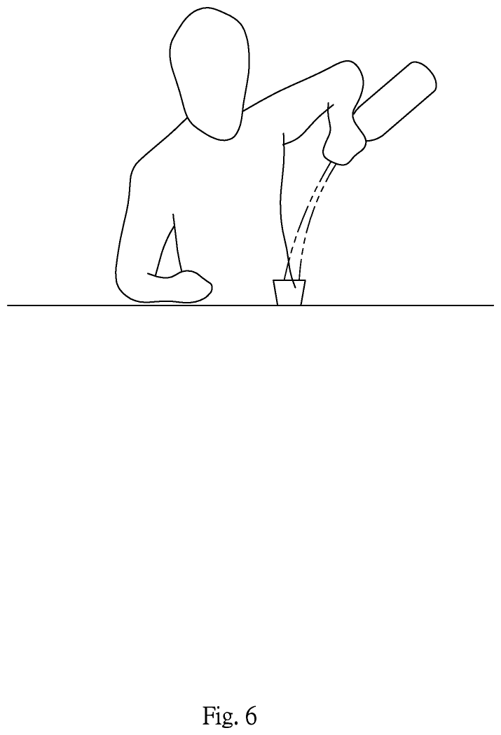

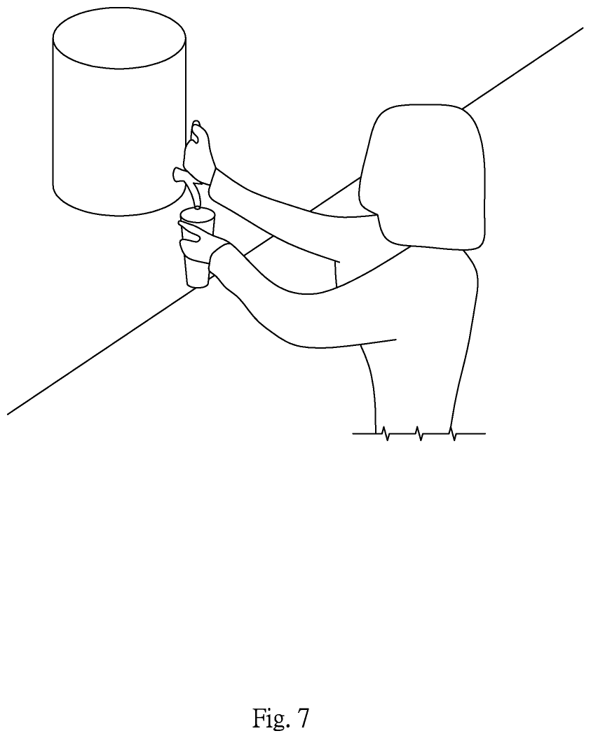

In addition, the machine vision also learns bartender poses so as to be capable of discriminating a wine pouring pose shown in FIG. 5, a liquor pouring pose shown in FIG. 6, or a beer poring pose with a beer keg nearby shown in FIG. 7, wherein a drink pouring pose image database of each bartender serving different drink types is created, such that even a bar has a plurality of bartenders, the conventional technologies can still easily identify and track them without mutual tangling.

In step 60, when a bar is opened to start operating, at least one image capturing device 2 focuses on the bar area direction to capture images of bottles in all cabinets and the bar counter 50 and transmits the captured images to the processing device 4. In this embodiment, in step 61, a drink type validating unit in the processing device 4 performs identification of whether a bottle 54 is displaced and validates corresponding type of the drink in the bottle 54 based on records in the memory device 3. If there is no displaced or moved bottle being detected, then in step 61, it is determined that running further steps is unnecessary, so the method returns to step 60 to continuously perform image capturing and storage. Next, in step 62, the drink pouring determining unit 42 in the processing device 4 determines whether a motion of pouring the drink into a glass 56 is performed based on whether the displaced bottle 54 is tilted for pouring with the mouth of the bottle 54 being targeted to the glass 56, and validates the type of the drink in the glass. Of course, those skilled in the art may easily understand that here, it may be further identified whether the drink poured is wine, liquor or beer based on recognition of the shape of the glass 56 and/or bodily motion of the bartender; and even further, in step 63, a timing unit 48 in the processing device 4 times pouring of the liquor to determine volume of the liquor poured into the glass to thereby determine whether the pour is 1 oz single-portion whiskey or 2 oz double-portion whiskey.

On the other hand, if the bartender takes up the bottle without pouring, but to wipe the cabinet for example, then in step 62, it is determined that the bartender does not perform a pouring motion, and the method returns to step 60 to continuously perform image capturing and storage, and identification of displacement of the bottle 54. In addition, although the above embodiment is illustrated with an example of pouring a drink into a glass, those skilled in the art may easily understand that the glass for receiving the poured drink is not limited to a drink glass, which may also be an intermediate container such as a shaker, wherein the bartender pours various types of drinks into the shaker to shake homogeneously, and finally pours the mixed drink from the shaker into a drink glass.

When it is identified that the bartender has performed a pouring motion, in step 64, the transaction determining unit 44 identifies a pre-demarcated zone on the bar counter 50. Generally, the bar counter 50 is required to have an enough width to place a glass poured with a drink, for a customer to drink by the bar counter 50 or to place a tray, or for the customer to check out. However, the bar counter 50 should not be too wide to cause operating inconvenience or create a sense of alienation. A usual width of the bar counter 50 is about 24 to 30 inches. In this embodiment, a width of about 5 inches in the central zone of the bar counter 50 is demarcated as a virtual border line, based on which a transaction zone 500 is defined. During the process in which the bartender serves the glass 56 with the drink to the customer, the machine vision identifies whether the glass 56 has crossed the transaction zone 500, and once it enters, stays, or crosses the transaction zone, determines that a transaction is established.

If the glass 56 poured with the drink does not cross the transaction area 500, it is deemed that the bartender tastes the drink, discards the drink, or consumes the drink by himself, which will not be rung up as external consumption, and the method returns to step 61 for continuously capturing and identifying. When it is identified in step 64 that the glass 56 has crossed the transaction zone 500, irrespective of whether it is voluntarily served by the bartender or voluntarily picked up by the customer, the method proceeds to step 65, in which step the memory device 3 records that the bartender has sold one glass of liquor, wine, beer, or cocktail. In this embodiment, as the bar may have several bartenders working simultaneously, payment reception of each bartender, irrespective of receiving a credit card payment, cash payment, or online payment, is recorded with the unique code of that bartender, such that upon work shift for example, a cash register 7 in signal connection with the processing device 4 transmits the total amount received by that bartender as a cash registration signal to the processing device 4; then, the processing device 4 validates whether each transacted glass of drink during the bartender's work hours has been rung up based on the total number of transactions and prices of individual glasses of drink for the whole night.

In this embodiment, the bar area sales automatic tracking and monitoring system 1 further comprises a communication device 8 configured to transmit the image data to a remote memory 80 for full documentation; therefore, if cross-check with the specific POS accounting data reveals that a bartender has an under-ringing beyond a reasonable range (e.g., a 5% transaction error) during his work shift duty for example, he will be flagged as either grossly neglected with business's money handling policies, or worse, the intentionally theft of sales revenues, once verified by the POS sales records. At which time, the employee is subjected to appropriate disciplinary actions, or immediate termination of employment. Such tracking data may also prevent false accusation of a bartender as thief for his/her incidental calculation negligence or charging error. Of course, although the embodiment uses a wireless communication device as an example, it is not a compulsory limitation, and application of a wired communication device will not affect implementation of the present disclosure.

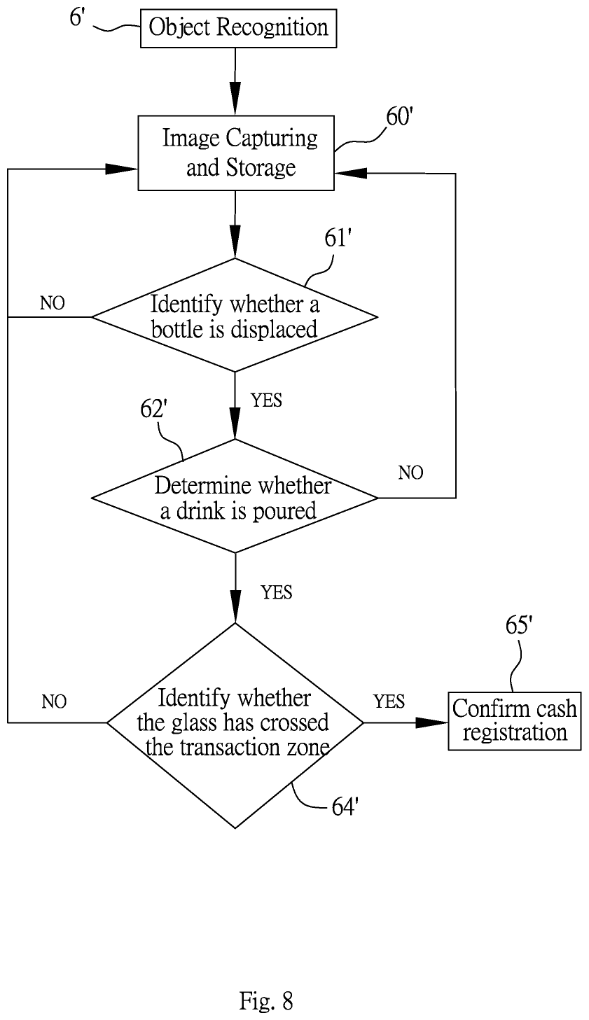

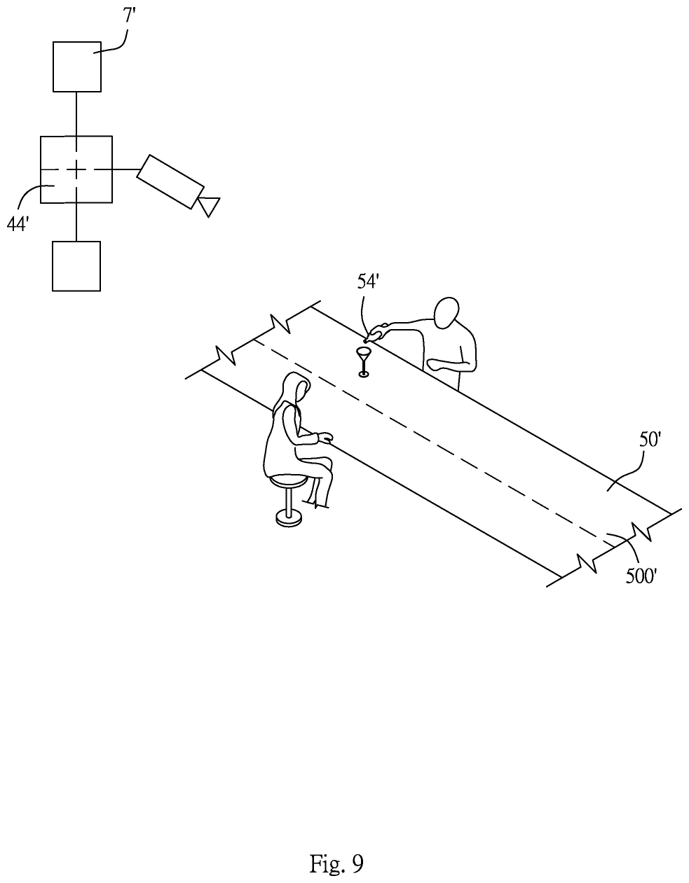

FIGS. 8 and 9 illustrate a second preferred embodiment of the bar area sales automatic tracking and monitoring method, wherein step 6′ of object recognition and part of step 60′, 61′ are identical to corresponding steps in the first preferred embodiment, which will not be repeated here. Different operations from the first embodiment occur after the database has been completely established and the bar starts business operation. In step 62′, the drink pouring determining unit may preliminarily identify whether the poured drink is wine, liquor, or beer based on the displaced bottle 54′ and the bartender's bodily motion in the image data. Even the estimation in this embodiment is not accurate, the present disclosure still exerts a considerable deterrent effect to the employees. Besides, the present disclosure is suitable for small bars with simple drink supplies. In cases of a relatively simple bar layout, in the step 64′ of transaction determination, the transaction determining unit 44′ is only required to take a single virtual middle line on the bar counter 50′ as a pre-demarcated transaction zone 500′, thereby significantly simplifying the whole transaction determining process.

Not like a large bar which has a complex environment such as customers directly sitting by the bar counter to drink, customers sometimes leaving their seats and approaching to the bar counter 50′ to order drinks and then returning to their seats, or customers sitting distantly from the bar counter 50′ and ordering via servers, diverse paying modes, and even several bartenders being tangled behind the bar counter, a small bar has a simpler transaction pattern, wherein after a transaction is confirmed, the present method easily proceeds to the cash registration confirming step 65′, wherein to determine whether a corresponding consumption has been rung up, it is only required to validate whether a corresponding ring-up signal is transmitted to the processing device from the cash register 7′ at particular timings of a customer's ordering, picking up a glass of drink, and exiting his seat.

Of course, besides pouring, a bartender's typical motion also includes adding ice tubes, adding water, cleaning and resetting a table, or passing through a bar counter gate to serve a customer ordering a drink at his/her seat. As specific motions can be learned and classified by machine vision, they can all be identified by the processing device. It is easily understood by those skilled in the art that the drink pouring determining unit here may have other manners of validating drink types in addition to recognizing packages of bottles, detecting drink pouring poses of the bartender, and recognizing the glassware used. For example, calibrating individual positions of bottles within the cabinet, and recording the detail of drink type at each position into the memory device, such that when the bartender picks up the bottle at the particular position and completes pouring, the drink pouring determining unit can accurately validate the drink type poured. In addition, to determine whether the liquor poured is in single portion or double portion for example, the liquor level in a crystal glass may also be referenced.

In the present disclosure, part of the steps or components disclosed above may be arbitrarily combined, which can also effectively track the transaction counts, render objective accounting data, accurately submit actual sales information of the bar area, and effectively deter theft behaviors, such that bar operation and management are more efficient and easily controllable, thereby sufficiently achieving the above and other objects of the present disclosure. Provision of the embodiments is only intended for facilitating understanding, not for limitation. Equivalent effects and other variations and modifications based on the appended claims all fall within the protection scope of the present disclosure.

What is claimed is:

1. A bar area sales automatic tracking and monitoring system, configured for a monitoring terminal to track sales of at least one bar area using an image capturing device; wherein a transaction zone is defined on a bar counter, and the image capturing device is configured to obtain at least one image data a including a drink bottle, a drink glass and the transaction zone; wherein the bar area sales automatic tracking and monitoring system comprises:
a memory device configured to store an image of the drink bottle; and
a processing device configured to receive a signal of the image data from the image capturing device,
wherein the processing device comprises a drink pouring determining unit and a transaction determining unit, wherein the drink pouring determining unit is configured to identify whether the drink bottle is tilted and a drink is poured into the glass based on the image data, and the transaction determining unit is configured to determine whether the glass poured with the drink has crossed the transaction zone based on the image data.

2. The bar area sales automatic tracking and monitoring system according to claim 1, wherein the memory device further stores a plurality of drink pouring pose image data of each bartender serving different drink types, and the drink pouring determining unit further validates type of the drink poured based on the drink pouring pose image data.

3. The bar area sales automatic tracking and monitoring system according to claim 1, further comprising a cash register in signal connection to the processing device, wherein the cash register is configured to validate whether a sale is rung up after the transaction determining unit determines that the glass has crossed the transaction zone.

4. The bar area sales automatic tracking and monitoring system according to claim 1, further comprising a communication device configured to transmit the image data to a remote memory for recording.

5. A bar area sales automatic tracking and monitoring method, configured for p tracking at least one bar area using an image capturing device in cooperation with a bar area sales automatic tracking and monitoring system, wherein a transaction zone is defined on the bar counter, the bar area sales automatic accounting and monitoring system comprises a memory device and a processing device in signal connection to the memory device, and the processing device comprises a drink pouring determining unit and a transaction determining unit; wherein the bar area sales automatic tracking and monitoring method comprises steps below:
a) obtaining, by the image capturing device, at least one image data including a drink bottle, a drink glass, and the transaction zone, and transmitting the image data to the processing device;
b) identifying, by the drink pouring determining unit, whether the image data includes a figure tilting the drink bottle and pouring a drink into the glass;
c) determining, by the transaction determining unit, the glass with the drink has crossed the transaction area; and
d) determining, by the transaction determining unit, that transaction of the glass of drink is completed when the glass with the drink has crossed the transaction area.

6. The bar area sales automatic tracking and monitoring method according to claim 5, wherein the memory device further stores bottle data of a plurality of different drink types; and the step b) further comprises validating, by the drink pouring determining unit, drink type of the glass of the drink in the transaction zone based on the image data of the tilted bottle.

7. The bar area sales automatic tracking and monitoring method according to claim 5, wherein the memory device further stores drink pouring pose image data of a bartender serving different drink types; and the step b) comprises a sub-step b1) in which the drink pouring determining unit validates drink type of the glass of the drink in the transaction zone based on a pose of the bartender tilting the bottle.

8. The bar area sales automatic tracking and monitoring method according to claim 7, wherein the step b) further comprises a sub-step b2) in which the drink pouring determining unit determines a drink volume poured in the glass based on drink pouring time duration of the bartender.

9. The bar area sales automatic tracking and monitoring method according to claim 5, wherein the bar area sales automatic tracking and monitoring system further comprises a cash register in signal connection to the processing device; and the bar area sales automatic tracking and monitoring method further comprises step e) in which after the step d), the processing device validates whether the transacted glass of drink in the transaction has been rung up based on a cash registration signal transmitted by the cash register.

10. The bar area sales automatic tracking and monitoring method according to claim 5, wherein the bar area sales automatic tracking and monitoring system further comprises a communication device, and the bar area sales automatic tracking and monitoring method further comprises step f) in which after the step a), the image data is transmitted to a remote memory for recording.
